(19) United States
(12) Patent Application Publication
(10) Pub. No.: US 2026/0084605 A1
(43) Pub. Date: Mar. 26, 2026

(54) EXTENDABLE GRAB HANDLE

(71) Applicant: GM GLOBAL TECHNOLOGY OPERATIONS LLC, Detroit, MI (US)

(72) Inventors: Hoiwoong Yang, Seoul (KR); Yunha Park, Seoul (KR); Leeyong Choi, Gwangmyeong-si (KR); Heecheol Kim, Incheon (KR); Jeonghoon Kim, Seoul (KR)

(73) Assignee: GM GLOBAL TECHNOLOGY OPERATIONS LLC, Detroit, MI (US)

(21) Appl. No.: 18/897,502

(22) Filed: Sep. 26, 2024

(51) Int. Cl. B60N 3/02

(52) U.S. Cl. CPC B60N 3/026

(57) ABSTRACT

An assembly includes a first attachment portion, a second attachment portion, and a handle assembly pivotably attached to the first attachment portion and the second attachment portion. The handle assembly is pivotable between a stowed position and a deployed position.

The handle assembly includes a first telescoping portion pivotably attached to the first attachment portion and a second telescoping portion pivotably attached to the second attachment portion, and a grab portion attached to the first telescoping portion and the second telescoping portion. The first telescoping portion and the second telescoping portion are configured to move the grab portion between a retracted position and at least one extended position.

### BACKGROUND

The present disclosure relates to a grab handle, and more particularly, to a grab handle for a vehicle passenger cabin.

Vehicle passenger cabins are accessed by occupants through access openings that are selectively accessed through vehicle doors that are movable between an open position allowing ingress and egress and a closed position preventing ingress or egress. To improve the ability of ingress or egress for the vehicle passenger cabin, grab handles may be located above door openings. The grab handles may assist passengers to steady themselves or to help lift themselves into or out of the vehicle.

### SUMMARY

Disclosed herein is an assembly. The assembly includes a first attachment portion, a second attachment portion, and a handle assembly pivotably attached to the first attachment portion and the second attachment portion. The handle assembly is pivotable between a stowed position and a deployed position. The handle assembly includes a first telescoping portion pivotably attached to the first attachment portion and a second telescoping portion pivotably attached to the second attachment portion, and a grab portion attached to the first telescoping portion and the second telescoping portion. The first telescoping portion and the second telescoping portion are configured to move the grab portion between a retracted position and at least one extended position.

In one aspect of the disclosure the assembly includes a latch configured to retain the grab portion in the at least one extended position.

In one aspect of the disclosure the first telescoping portion includes a first base segment pivotably attached to the first attachment portion and a first intermediate segment in engagement with the first base segment and the grab portion.

In one aspect of the disclosure the second telescoping portion includes a second base segment pivotably attached to the second attachment portion and a second intermediate segment in engagement with the second base segment and the grab portion.

In one aspect of the disclosure the latch includes a first detent for engaging a first detent opening in at least one of the first base segment or the first intermediate segment.

In one aspect of the disclosure the latch includes a second detent for engaging a second detent opening in at least one of the second base segment or the second intermediate segment.

In one aspect of the disclosure the first detent and the second detent are each attached to a connecting rod.

In one aspect of the disclosure the connecting rod includes an engagement surface projecting outward from the grab portion.

In one aspect of the disclosure the connecting rod includes a stop configured to engage a stop on the grab portion.

In one aspect of the disclosure the handle assembly includes a first damper having first end fixed relative to the first base segment and a second end fixed relative to the grab portion.

In one aspect of the disclosure the handle assembly includes a second damper having a first end fixed relative to the second base segment and a second end fixed relative to the grab portion.

In one aspect of the disclosure the first base segment, the first intermediate segment, the second base segment, and the second intermediate segment each include a reinforcement plate.

In one aspect of the disclosure the handle assembly includes a deployment retainer configured to engage the first attachment portion and the handle assembly to maintain the handle assembly in the deployed position.

Disclosed herein is a method of operating a grab handle on a vehicle. The method includes pivoting a handle assembly of the grab handle from a stowed position to a deployed position by pivoting the handle assembly about a first attachment portion fixed relative to the vehicle and a second attachment portion fixed relative to the vehicle. The assembly includes a first attachment portion, a second attachment portion, and a handle assembly pivotably attached to the first attachment portion and the second attachment portion. The handle assembly is pivotable between a stowed position and a deployed position. The handle assembly includes a first telescoping portion pivotably attached to the first attachment portion and a second telescoping portion pivotably attached to the second attachment portion, and a grab portion attached to the first telescoping portion and the second telescoping portion. The first telescoping portion and the second telescoping portion are configured to move the grab portion between a retracted position and at least one extended position. The method also includes telescoping the grab portion to a desired longitudinal position and activating a latch on the grab portion to secure the grab portion in the desired longitudinal position.

In one aspect of the disclosure the first telescoping portion includes a first base segment pivotably attached to the first attachment portion and a first intermediate segment in engagement with the first base segment and the grab portion and the second telescoping portion includes a second base segment pivotably attached to the second attachment portion and a second intermediate segment in engagement with the second base segment and the grab portion.

In one aspect of the disclosure activating the latch on the grab portion includes moving a first detent on the latch into engagement with a first detent opening and moving a second detent on the latch into engagement with a second detent opening.

In one aspect of the disclosure the first detent opening is at least partially defined by one of the first base segment or the first intermediate segment and the second detent opening is at least partially defined by one of the second base segment or the second intermediate segment.

Disclosed herein is a vehicle. The vehicle includes a passenger cabin at least partially defined by a vehicle body and an egress opening and a grab handle located adjacent the egress opening. The grab handle includes a first attachment portion, a second attachment portion, and a handle assembly pivotably attached to the first attachment portion and the second attachment portion. The handle assembly is pivotable between a stowed position and a deployed position.

The handle assembly includes a first telescoping portion pivotably attached to the first attachment portion and a second telescoping portion pivotably attached to the second attachment portion, and a grab portion attached to the first telescoping portion and the second telescoping portion. The first telescoping portion and the second telescoping portion are configured to move the grab portion between a retracted position and at least one extended position.

### BRIEF DESCRIPTION OF DRAWINGS

FIG. 1 is a schematic illustration of a vehicle incorporating a grab handle according to this disclosure.

FIG. 2 schematically illustrates a front perspective view of the grab handle of FIG. 1 in a deployed position with a grab portion in a retracted position.

FIG. 3 schematically illustrates the front perspective view of the grab handle of FIG. 1 in the deployed position with the grab portion in an extended position.

FIG. 4 schematically illustrates a rear perspective view of the grab handle of FIG. 1 in the deployed position with the grab portion in the extended position.

FIG. 5 schematically illustrates a latch within the grab handle of FIG. 1.

FIG. 6 is a cross-sectional view taken along line 6-6 of FIG. 4.

FIG. 7 is a flow 1 diagram of an example method of utilizing the grab handle of FIG. 1.

Some embodiments of the present disclosure are now described, by way of example only, and with reference to the accompanying drawings. The same reference number represents the same element or the same type of element on all drawings.

### DETAILED DESCRIPTION

Those having ordinary skill in the art will recognize that terms such as “above,” “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps.

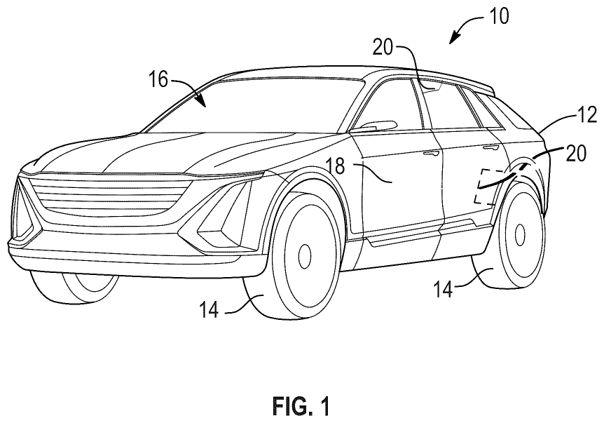

Referring to the FIGS., wherein like numerals indicate like parts referring to the drawings, wherein like reference numbers refer to like components, FIG. 1 is a schematic view of an example vehicle 10 including a vehicle body 12 supported by wheels 14. The vehicle body 12 at least partially defines a passenger cabin 16. The passenger cabin 16 is accessible through one of the vehicle doors 18 that allow for ingress and egress from the passenger cabin 16. To assist the passengers with ingress and egress, at least one grab handle 20, such as an assist handle, is secured relative to the vehicle body 12. The grab handle 20 can be located above an opening for the vehicle doors 18 in the passenger cabin 16 or on a lateral side of the opening for the vehicle doors 18 in the passenger cabin 16 as shown in dashed lines in FIG. 1.

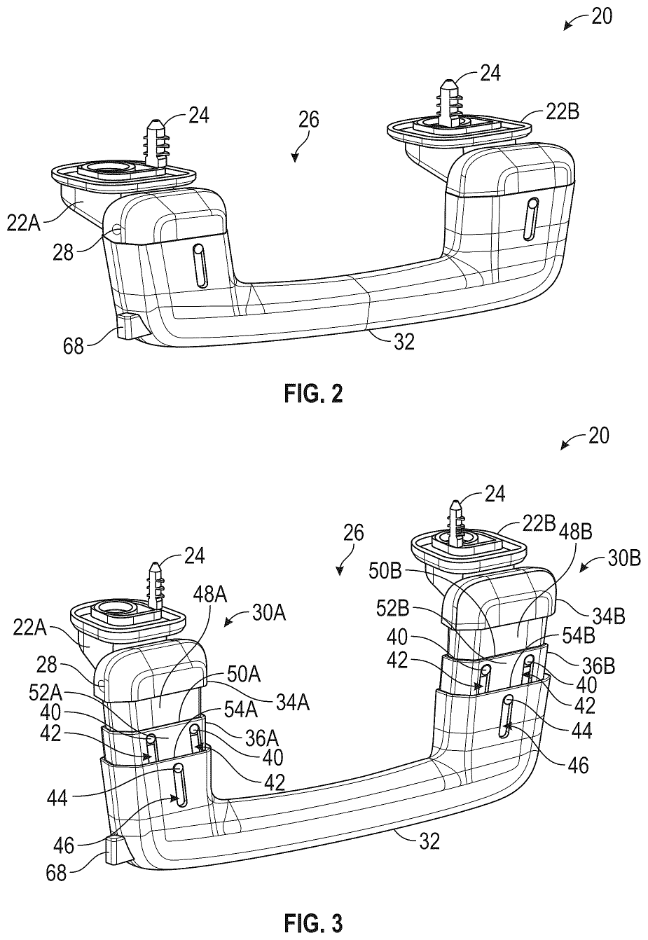

FIG. 2 illustrates the grab handle 20 of FIG. 1 shown in a deployed position. The grab handle 20 can move between a stowed position and a deployed position to assist a passenger entering or exiting the vehicle 10. In particular, for larger vehicles with higher roofs and more ground clearance, it can be difficult to reach the grab handle 20 if the passenger is not sufficiently tall. One feature of this disclosure is to provide a handle assembly that will assist passengers with varying amounts of reach to be able to the grab handle 20 as discussed in greater detail below.

The grab handle 20 includes a first attachment portion 22A and a second attachment portion 22B that are secured relative to the vehicle body 12 with fasteners 24. Additional fasteners, such as bolts (not shown), can provide further strength to secure the grab handle 20 to the vehicle body 12. A handle assembly 26 is pivotably attached to the first attachment portion 22A and the second attachment portion 22B about a pivotable connection utilizing pins 28 that extends through a portion of the handle assembly 26 and a corresponding one of the first and second attachment portions 22A, 22B. The pivotable connection between the handle assembly 26 and the first and second attachment portions 22A, 22B allows the handle assembly 26 to pivot from the stowed position to the deployed position (FIGS. 2-4) to allow the passenger to grab the grab handle 20 for ingress, egress, or balance during operation of the vehicle 10. The pivotable connection can also be biased toward the stowed position, such as through the use of a spring, to assist the handle assembly 26 to return to the stowed position when no longer needed by the passenger.

In the illustrated example, the handle assembly 26 includes a first telescoping portion 30A pivotably attached to the first attachment portion 22A with one of the pins 28 and a second telescoping portion 30B pivotably attached to the second attachment portion 22B with one of the pins 28. The handle assembly 26 also includes a grab portion 32 having opposing ends attached to the first and second telescoping portions 30A, 30B. The first and second telescoping portions 30A, 30B are configured to have varying lengths to allow the grab portion 32 to be positioned in a number of different positions, such as between a retracted position (FIG. 2) and an extended position (FIG. 3). In the retracted position, the first and second telescoping portions 30A, 30B each extend along a first length and in extended position, the first and second telescoping portions 30A, 30B each extend along a second length that is greater than the first length. The first and second telescoping portions 30A, 30B can also move between the intermediate position between the retracted position of FIG. 2 and the fully extended position of FIG. 3.

The first telescoping portion 30A includes a first base segment 34A pivotably attached to the first attachment portion 22A and a first intermediate segment 36A in engagement with the first base segment 34A and the grab portion 32. Similarly, the second telescoping portion 30B includes a second base segment 34B pivotably attached to the second attachment 22B portion and a second intermediate segment 36B in engagement with the second base segment 34B and the grab portion 32.

As shown in FIG. 3, the first and second base segments 34A, 34B each include a pair of guide pins 40 that are accepted within a pair of guide slots 42 in the first and second intermediate segments 36A, 36B, respectively. Also, the first and second intermediate segments 36A, 36B each include a guide pin 44 that is accepted within a guide slot 46 in the grab portion 32, respectively. One feature of the guide pins 40, 44 and the guide slots 42, 46 is the ability to maintain the first and second telescoping portions 30A, 30B in alignment while the grab portion 32 moves between different longitudinal positions. The guide pins 40, 44 and guide slots 42, 46 can also limit longitudinal movement of the first and second telescoping portions 30A, 30B.

As shown in FIG. 3, the first and second base segments 34A, 34B each include an outer surface 48A, 48B that is in engagement with in located inward from an inner surface 50A, 50B on the first and second intermediate segments 36A, 36B. The first and second intermediate segments 36A, 36B each include an outer surface 52A, 52B opposite the inner surface 50A, 50B that faces an inner guide surface 54A, 54B on the grab portion 32.

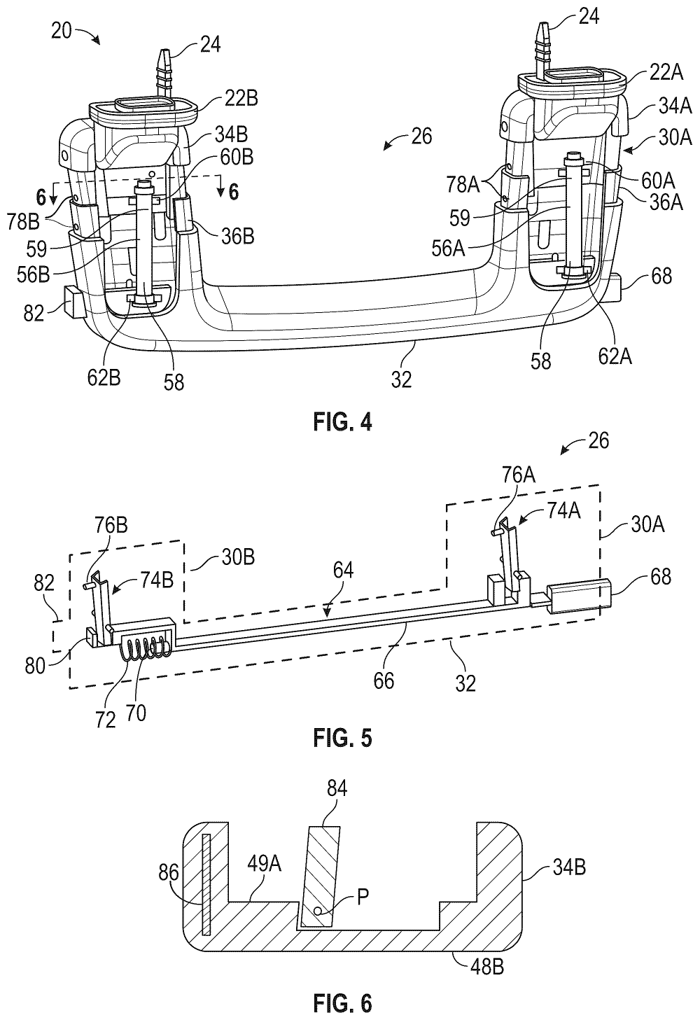

As shown in FIGS. 4 and 6, a deployment retainer 84 is pivotably attached about pivot point P to the first base segment 34A adjacent an inner surface 49A opposite the first outer surface 48A. The deployment retainer 84 is configured to pivot between an extended position engaging the first attachment portion 22A to prevent the handle assembly 26 from moving from the deployed position back to the stowed position. One feature of the deployment retainer 84 is the ability to maintain the grab handle 20 within reach of smaller passengers, such as children, that may not be able to reach the grab handle 20 when it is in the stowed position. The deployment retainer 84 can also be located on the second base segment 34B in addition to or in place of on the first base segment 34A.

In the illustrated example, first and second dampeners 56A, 56B can engage the first and second base segments 34A, 34B, respectively, and the grab portion 32 to provide a fluid movement when moving the grab portion 32 between the retracted and extended positions. The first and second dampeners 56A, 56B can also apply a retracting force that biases the grab portion 32 from one of the extended position to the retracted position to assist in the grab handle 20 returning to the stowed position when no longer being used by the passenger.

In the illustrated example of FIG. 4, the first and second dampeners 56A, 56B include cylindrical fluid dampeners having a piston 58 having a proximal end located in a fluid housing 59 and a distal end in engagement with grab portion 32. However, the illustrated orientation of the first and second dampers 56A, 56B can be reversed in this disclosure. A first end portion of the first and second dampeners 56A, 56B engage first and second locking feature 60A, 60B on the first and second base segments 34A, 34B and a second end portion of the first and second dampeners 56A, 56B engage first and second locking features 62A, 62B on the grab portion 32.

To maintain the grab portion 32 in one of the retracted or extended positions, a latch 64 is utilized as shown in FIGS. 2-5. FIG. 5 illustrates the handle assembly 26 in dashed lines to reveal the latch 64 located within the handle assembly 26. In the illustrated example, the latch 64 extends longitudinally through the grab portion 32 between opposing ends of a base of the grab portion 32. In the illustrated example, the latch 64 includes a rod 66 having a user engagement surface 68 or button located on a first end and a spring engagement protrusion 70 located on an opposite second end of the rod 66. The spring engagement protrusion 70 is configured to engage a spring 72 that is also in engagement with the grab portion 32 for biasing the latch 64 in a direction of the user engagement surface 68.

The latch 64 secures the grab portion 32 in one of the longitudinal positions by utilizing at least one of a first retainer 74A and a second retainer 74B. In the illustrated example, the first retainer 74A on the latch 64 is located adjacent a first end of the rod 66 and the second retainer 74B is attached adjacent a second end of the rod 66. The first retainer 74A includes a first detent 76A projecting in a direction of the second end of the rod 66 away from the user engagement surface 68. The second retainer 74B includes a second detent 76B projecting from the second retainer 74B in a direction of the second end of the rod 66 away from the user engagement surface 68.

As shown in FIGS. 4-5, the first and second detents 76A, 76B are configured to be accepted within first detent openings 78A in the first telescoping portion 30A and second detent openings 78B in the second telescoping portion 30B. In the illustrated example, the first detent openings 78A extend through and are at least partially defined by one or both of the first base segment 34A or the first intermediate segment 36A and the second detent openings 78B extend through and are at least partially defined by one or both of the second base segment 34B or the second intermediate segment 36B.

During operation of the grab handle 20, a user applies a force to the user engagement surface 68 to compress the spring 70 adjacent the second end of the rod 66 to direct the first and second detents 76A, 76B into their respective first and second detent openings 78A, 78B. When pressure is released from the user engagement surface 68, the spring 70 biases first and second detents 76A, 76B out of their respective first and second detent openings 78A, 78B to allow the grab portion 32 of the handle assembly 26 to return to the retracted position or into a different one of the extended positions.

As shown in FIGS. 4-5, the connecting rod 66 includes a stop surface 80 at a distal end configured to engage a stop 82 in the grab portion 32. In the illustrated example, the stop 82 protrudes from an outer surface of the grab portion 32 and limits an amount of travel a user can apply to the latch 64 through applying pressure to the user engagement surface 68.

As shown in FIG. 6, each of the first and second base segments 34A, 34B, the first and second intermediate segments 36A, 36B can include a reinforcement plate 86. In one example, the reinforcement plate 86 is comprised of a metallic material and can be formed into the above identified segments during an injection molding process. Either of the first or second detent openings 78A, 78B can extend through corresponding openings in the reinforcement plate 86 to strengthen the attachment of the first and second detents 76A, 76B respectively.

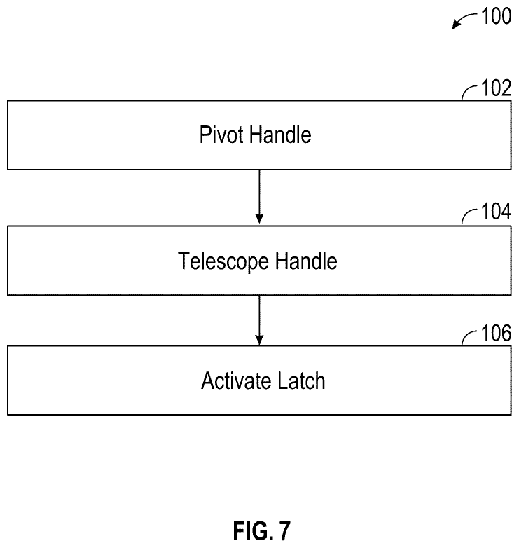

FIG. 7 illustrates a flowchart of a method 100 of operating the grab handle 20. The method 100 begins at block 102 (“Pivot Handle”) with pivoting the handle assembly 26 of the grab handle 20 from a stowed position to a deployed position. The handle assembly 26 is pivoted about first and second attachment portions fixed relative to the vehicle 10 and a second attachment portion fixed relative to the vehicle 10. The method 100 then proceeds to block 104.

At block 104 (“Telescope Handle”), the grab portion 32 is telescoped to a desired longitudinal position. The grab portion 32 is able to telescope through the use of the first and second telescoping positions 30A, 30B being able change in length as described above. The method then proceeds to block 106.

At block 106 (“Activate Latch”), the latch 64 is activated to secure the grab portion 32 in the desired longitudinal position. Activating the latch 64 on the grab portion 32 includes moving the first detent 76A on the latch 64 into engagement with a first detent opening 78A and moving the second detent 76B on the latch 64 into engagement with a second detent opening 78B as described above.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure not be limited to the particular embodiments disclosed but will include embodiments falling within the scope thereof.

What is claimed is:

1. An assembly, comprising:
a first attachment portion;
a second attachment portion; and
a handle assembly pivotably attached to the first attachment portion and the second attachment portion and the handle assembly is pivotable between a stowed position and a deployed position, wherein the handle assembly includes:
a first telescoping portion pivotably attached to the first attachment portion;
a second telescoping portion pivotably attached to the second attachment portion; and
a grab portion attached to the first telescoping portion and the second telescoping portion, wherein the first telescoping portion and the second telescoping portion are configured to move the grab portion between a retracted position and at least one extended position.

2. The assembly of claim 1, including a latch configured to retain the grab portion in the at least one extended position.

3. The assembly of claim 2, wherein the first telescoping portion includes a first base segment pivotably attached to the first attachment portion and a first intermediate segment in engagement with the first base segment and the grab portion.

4. The assembly of claim 3, wherein the second telescoping portion includes a second base segment pivotably attached to the second attachment portion and a second intermediate segment in engagement with the second base segment and the grab portion.

5. The assembly of claim 4, wherein the latch includes a first detent for engaging a first detent opening in at least one of the first base segment or the first intermediate segment.

6. The assembly of claim 5, wherein the latch includes a second detent for engaging a second detent opening in at least one of the second base segment or the second intermediate segment.

7. The assembly of claim 6, wherein the first detent and the second detent are each attached to a connecting rod.

8. The assembly of claim 7, wherein the connecting rod includes an engagement surface projecting outward from the grab portion.

9. The assembly of claim 8, wherein the connecting rod includes a stop configured to engage a stop on the grab portion.

10. The assembly of claim 4, including a first damper having first end fixed relative to the first base segment and a second end fixed relative to the grab portion.

11. The assembly of claim 10, including a second damper having a first end fixed relative to the second base segment and a second end fixed relative to the grab portion.

12. The assembly of claim 4, wherein the first base segment, the first intermediate segment, the second base segment, and the second intermediate segment each include a reinforcement plate.

13. The assembly of claim 1, including a deployment retainer configured to engage the first attachment portion and the handle assembly to maintain the handle assembly in the deployed position.

14. A method of operating a grab handle on a vehicle, the method comprising:
pivoting a handle assembly of the grab handle from a stowed position to a deployed position by pivoting the handle assembly about a first attachment portion fixed relative to the vehicle and a second attachment portion fixed relative to the vehicle, wherein the handle assembly includes:
a first telescoping portion pivotably attached to the first attachment portion;
a second telescoping portion pivotably attached to the second attachment portion; and
a grab portion attached to the first telescoping portion and the second telescoping portion, wherein the first telescoping portion and the second telescoping portion are configured to move the grab portion into at least one extended position;
telescoping the grab portion to a desired longitudinal position; and
activating a latch on the grab portion to secure the grab portion in the desired longitudinal position.

15. The method of claim 14, wherein the first telescoping portion includes a first base segment pivotably attached to the first attachment portion and a first intermediate segment in engagement with the first base segment and the grab portion and the second telescoping portion includes a second base segment pivotably attached to the second attachment portion and a second intermediate segment in engagement with the second base segment and the grab portion.

16. The method of claim 15, wherein activating the latch on the grab portion includes moving a first detent on the latch into engagement with a first detent opening and moving a second detent on the latch into engagement with a second detent opening.

17. The method of claim 16, wherein the first detent opening is at least partially defined by one of the first base segment or the first intermediate segment and the second detent opening is at least partially defined by one of the second base segment or the second intermediate segment.

18. A vehicle, comprising:
a passenger cabin at least partially defined by a vehicle body, wherein the passenger cabin includes an egress opening; and
a grab handle located adjacent the egress opening, wherein the grab handle includes:
a first attachment portion fixed relative to the vehicle body;
a second attachment portion fixed relative to the vehicle body; and
a handle assembly pivotably attached to the first attachment portion and the second attachment portion and the handle assembly is pivotable between a stowed position and a deployed position, wherein the handle assembly includes:
a first telescoping portion pivotably attached to the first attachment portion;
a second telescoping portion pivotably attached to the second attachment portion; and
a grab portion attached to the first telescoping portion and the second telescoping portion, wherein the first telescoping portion and the second telescoping portion are configured to move the grab portion between a retracted position and an extended position.

19. The vehicle of claim 18, wherein the first telescoping portion includes a first base segment pivotably attached to the first attachment portion and a first intermediate segment in engagement with the first base segment and the grab portion and the second telescoping portion includes a second base segment pivotably attached to the second attachment portion and a second intermediate segment in engagement with the second base segment and the grab portion.

20. The vehicle of claim 19, including a latch having a first detent for engaging a first detent opening in at least one of the first base segment or the first intermediate segment and the latch includes a second detent for engaging a second detent opening in at least one of the second base segment or the second intermediate segment.
